(19) United States
(12) Patent Application Publication
(10) Pub. No.: US 2015/0076996 A1
(43) Pub. Date: Mar. 19, 2015

(54) LIGHTING SYSTEM AND CONTROL UNIT FOR SAME

(71) Applicant: ZUMTOBEL LIGHTING GMBH, Dornbirn (AT)

(72) Inventor: Daniel Flatz, Lustenau (AT)

(21) Appl. No.: 14/391,595

(22) PCT Filed: Apr. 10, 2013
(86) PCT No.: PCT/EP2013/057461

§ 371 Date: Oct. 9, 2014

(30) Foreign Application Priority Data
Apr. 12, 2012 (DE) 10 2012 205 964.4

(51) Int. Cl. H05B 37/02

(52) U.S. Cl. CPC H05B 37/0272; H05B 37/0227; H05B 37/0218
USPC 315/158; 315/291

(57) ABSTRACT

A lighting system has at least one control unit which is designed to transmit control instructions, in particular control instructions corresponding to the DALI and/or DSI standard, to a plurality of operating devices assigned thereto, wherein the control instructions are generated on the basis of control information fed to the control unit. The control unit receives the control information in wireless fashion.

The present invention relates to a lighting system having at least one control unit that is designed to transmit to the luminaires associated therewith control commands. The control commands may particularly be commands based on the DALI and/or DSI standard. In addition, the present invention relates to a corresponding control unit for use in a lighting system.

Lighting systems in which the behaviors of a plurality of luminaires in the distributed arrangement are coordinated with one another are already known and are frequently used in order to optimize the lighting as a whole but also the power consumption in a building. Thus, firstly, a standard behavior from the luminaires improves the overall appearance, and secondly, the fact that the brightness of the various luminaires is set on the basis of the available daylight, for example, allows power consumption to be reduced. Furthermore, by way of example, the use of presence sensors also allows the lighting to be set automatically on the basis of whether or not a particular area contains people.

Larger lighting systems are generally based on the principle of transmitting to the luminaires control commands that are then implemented by the relevant operating devices of the luminaires in a suitable manner. Where it was previously customary to transmit analog signals—for example a variable DC voltage of between 1 and 10 volts—for brightness control, it is now customary to transmit control commands in digital form. The communication implemented as a result between control unit and lamp operating unit is not only being improved; there is also a wider variety of options available for actuating the luminaires or generally for communication. Recently, for example, what is known as the DALI (Digital Addressable Lighting Interface) standard has gained wide acceptance. This is a communication protocol for data transmission particularly for brightness control for luminaires that not only allows the transmission of commands to luminaires but furthermore also provides the opportunity to request and record the operating state of individual luminaires within the context of status queries. Fault conditions and defects in individual subscribers in the lighting system can be detected very easily and effectively in this manner.

In systems based on the DALI standard, the digital control commands are transmitted via a specific or separate data line that is isolated from the general power supply, what is known as the DALI bus. Even in other lighting systems that allow central actuation of luminaires in a distributed arrangement, signal transmission usually takes place via an isolated data line. Although systems are also known in which what is known as the powerline carrier method is used to transmit control information via the lines provided for supplying power, these are specific solutions that are rather less well suited to general use in larger buildings.

The laying of a separate line for transmitting the data or control commands is not a problem if it is planned from the outset and accordingly takes place when the building, for example, is actually constructed. If, on the other hand, the lighting of a building is intended to be updated at a later time such that, in addition to the previous simple switching on and off of the luminaires, convenient brightness control is now also made possible, this always results in an extremely high level of involvement, since separate lines subsequently need to be laid for the signal transmission. Often, the associated involvement is of such a level that appropriate conversion of the lighting to convenient digital actuation of the luminaires is not viable. In other cases again, the laying of additional data transmission lines is not possible at all or not permissible, for example if the building is protected.

Since, despite everything, there is the trend toward firstly coordinating the behaviors of luminaires to one another and secondly optimizing the operating behaviors of said luminaires in respect of the available exterior light, there is an increasingly extensive search for solutions that avoid the involved laying of data lines for the purpose of producing more complex lighting systems. The present invention is based on the object of providing an appropriate solution thereto.

This object is achieved by a lighting system having the features of claim 1 and by a corresponding control unit according to claim 11. Advantageous developments of the invention are the subject matter of the dependent claims.

The solution according to the invention provides a system for actuating luminaires that can be produced with a relatively low level of involvement. Particularly when an already existing lighting system needs to be converted or upgraded, the solution according to the invention provides significant advantages since the involvement for laying additional lines or the like is reduced to a minimum. In this case, the solution according to the invention is based on the concept that the lighting system has one or more control units which are each designed to transmit to a plurality of luminaires associated therewith, or to the operating devices of the luminaires, control commands, for example based on the DALI standard and/or also the known DSI standard. In this case, the control commands are generated by the control units themselves on the basis of control information that is supplied thereto, the invention providing for the control unit to receive said control information wirelessly.

The invention thus proposes a lighting system having at least one control unit that is designed to transmit to a plurality of operating devices associated therewith control commands, particularly control commands based on the DALI and/or DSI standard, wherein the control commands are generated on the basis of control information that is supplied to the control unit and the invention provides for the control unit to receive said control information wirelessly.

In addition, the invention proposes a control unit for use in a lighting system, wherein the control unit is designed to transmit to a plurality of operating devices associated therewith control commands, particularly control commands based on the DALI and/or DSI standard, wherein the control commands are generated on the basis of control information that is supplied to the control unit and the invention provides for the control unit to have means for wirelessly receiving the control information.

The basic concept of the design according to the invention thus involves the control units, which are ultimately responsible for actuating the luminaires or operating devices associated therewith, taking wirelessly transmitted information as a basis for generating the control commands. Since the control units are usually arranged at least in proximity to their associated luminaires, the involvement for constructing or laying a data line from the control unit to the operating devices is relatively low, since only short distances need to be overcome. Further wiring of the control unit to other components of the lighting system, on the other hand, particularly to operator control elements, a central control unit or the like, is no longer required and is accordingly dispensed with, the result of which is that it is possible to dispense with general networking of the various control units or control components of the lighting system using a data line. The resultant involvement for converting an existing lighting system to a lighting system that allows digital actuation of the various luminaires is accordingly extremely low. Despite everything, all the advantages of a digital control system for actuating luminaires can also be used in the solution according to the invention.

Developments of the invention relate particularly to concepts that firstly optimize the actuation of the operating devices within the group associated with the control unit and secondly further reduce the involvement for assembling the system.

Thus, according to a preferred exemplary embodiment of the invention, provision may be made for the control unit to actuate the operating devices associated therewith in a standard manner. Each control unit thus has an associated group of operating devices that is then actuated within the context of what are known as broadcast commands. That is to say that the control commands transmitted by the control unit do not contain any individual address information that is used to individually actuate a luminaire. Instead, the operating devices of the luminaires in the system are grouped logically such that the luminaires in a respective group fundamentally have an operating behavior that is the same or identical.

In this case, provision is preferably made for the operating devices to be actuated via the respective control unit using a data line. As already mentioned, the group association means that there is provision for the control unit to be arranged in proximity to the luminaires associated therewith anyway. Usually, there is even a common housing or support element provided for the control unit and the luminaire group associated therewith, which makes laying a short data line in this area very simple. In addition or alternatively, however, provision may also be made for at least some of the operating devices that are associated with a control unit to receive control commands wirelessly therefrom. This is useful particularly in the case of luminaires that are in particular positions and for which the laying of a data line is accordingly not appropriate or possible. These luminaires can then additionally be provided with or connected to a corresponding receiver that allows wireless communication, for example using the known Bluetooth standard, between control unit and luminaire.

As already explained above, the solution according to the invention allows the involvement for laying data lines to be reduced by virtue of the control information that is required for producing the control commands being transmitted to the control units wirelessly. In this case, according to a preferred exemplary embodiment, provision may be made for the system to have a plurality of control units, in which case at least some of the control information supplied to a control unit also comes from one of the other control units. In this case, the control units are thus designed such that they communicate with one another and interchange particularly information concerning their operating state, for example in order to ensure generally coordinated behavior from the luminaires. In addition, however, control information may also come from a sensor in this case, for example a presence or brightness sensor. This information is then processed as appropriate by the control unit in each case in order to adjust the operation of the associated luminaires in a suitable manner. In this case too, provision is preferably made for the involvement for assembling the sensor and for integration into the lighting system to be kept as low as possible. Since corresponding sensors often require a specific arrangement inside or outside a building, however, the laying of data lines or else of lines for supplying power is often associated with a particularly high level of involvement in this case. Accordingly, according to a particularly preferred exemplary embodiment, provision may also be made for the sensors each to have an independent power supply, particularly a battery or the like.

Naturally, the lighting system according to the invention may also have operator control elements that allow a user to control the brightness, for example to call predefined lighting scenarios or simply to increase or reduce the brightness generally. The information coming from such an operator control element is also preferably transmitted to the control units wirelessly, with particular provision being able to be made for the lighting system to have a respective plurality of operator control elements and for the latter to be designed to interchange information with one another concerning the control information transmitted to the control units. This is relevant in so far as modern operator control elements often have dedicated indicators or displays that are used to indicate the current state of the lighting system or a lighting scenario chosen by the user. By interchanging the information with one another, all the operator control elements are certain to each present the same information and to actually reproduce the current state of the lighting system.

Ultimately, the solution according to the invention can thus be used to provide a lighting system that provides all the opportunities of a classical, centrally controlled lighting system in terms of its control options and opportunities for incorporating external information that comes from sensors or the like, for example, but with, particularly, the involvement for assembling the system being significantly reduced in comparison with previously known solutions.

The invention will be explained in more detail below with reference to the accompanying drawing, in which:

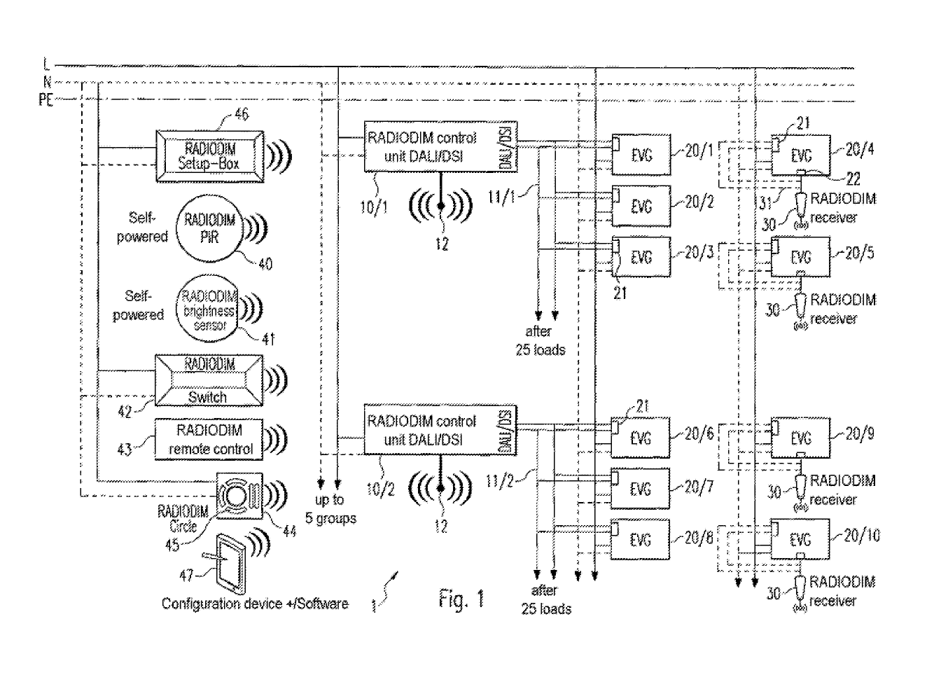

FIG. 1 schematically shows the general design of a lighting system according to the invention, and

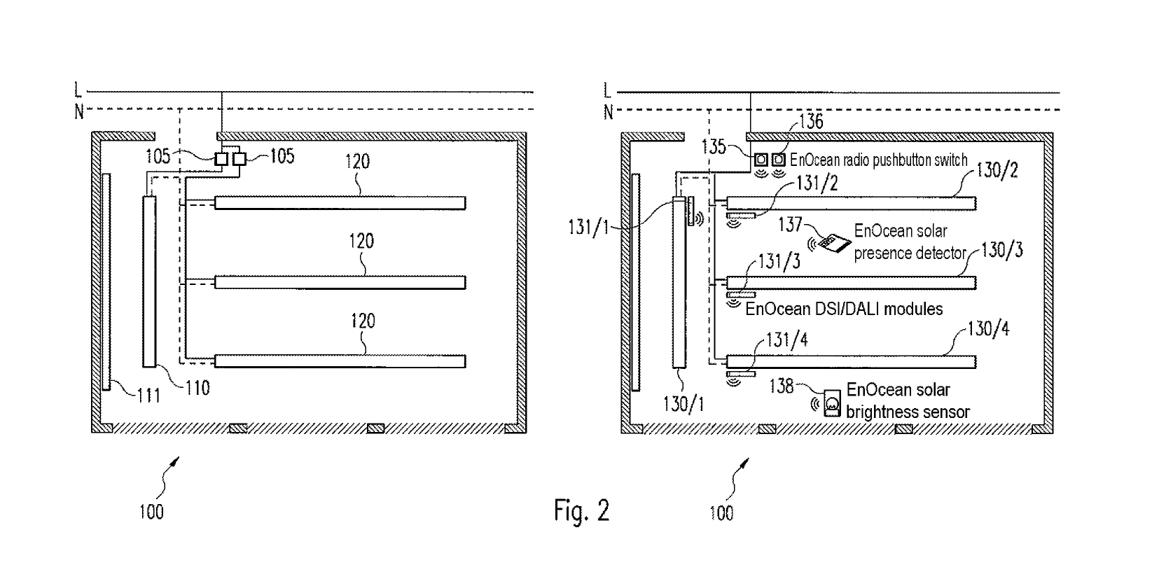

FIG. 2 shows the procedure for converting an existing lighting system to a system according to the present invention.

First of all, the general design of a lighting system according to the invention will be explained with reference to FIG. 1. In particular, the units involved in the system and the interaction of said units will be explained. Next, a specific example will be used to show the way in which the solution according to the invention can be used to upgrade or convert an already existing lighting system.

The core concept of the solution according to the invention is that the design for laying data lines for actuating the various units in the system is meant to be kept as low as possible. In particular, such lines are meant to be laid only if this is possible with a reasonable level of involvement. In contrast to previously known systems, the system shown in FIG. 1 and provided generally with the reference symbol 1 is accordingly distinguished in that the various units are not all connected to one another via a common bus or data line. On the other hand, the available lines for supplying power need to be used as effectively as possible, which ultimately results in almost all the components being connected to the general power supply. Exceptions are just some units for generating control information, particularly sensors, which will be explained in more detail later.

In principle, the lighting system 1 according to the invention is designed such that the individual luminaires, which in this case are each represented by corresponding operating devices or electronic ballasts 20, are divided into groups. In this case, each group is associated with a control unit 10 that actuates the operating devices or electronic ballasts 20 associated therewith by transmitting digital control commands. In the exemplary embodiment shown, signal transmission based on the known DALI standard and/or DSI standard is provided, but the concept according to the invention can naturally also be transferred to other solutions for digital actuation.

The operating devices 20 associated with a controller or a control unit 10 are thus connected to the output of the control unit 10 by means of data lines 11. In the case of signal transmission based on the DALI standard, a respective local DALI bus, to which the ballasts 20 in the respective group are connected, is thus formed on the output side. According to the example shown, up to 25 ballasts can be connected, this number naturally also being able to be adjusted in accordance with the respective requirements.

In this case, a special feature of the lighting system 1 according to the invention is also that individual luminaires can be actuated wirelessly by the control unit 10/1 associated therewith. In the exemplary embodiment shown, the ballasts 20/4 and 20/5 have been associated with the first group, for example, that is to say with the control unit 10/1, whereas on the other hand the ballasts 20/9 and 20/10 belong to the second group and are actuated by the control unit 10/2. This case involves luminaires that are arranged at a greater distance from the respective control unit 10/1 or 10/2, for example, or are in a position in which the laying of the control line 11/1 or 11/2 to the electronic ballast 20 can be implemented only with a very high level of involvement. For this reason, each of these electronic ballasts then has a corresponding receiver 30 that is designed to communicate wirelessly with the respective control unit 10/1 or 10/2. The output side of this receiver 30 is then in turn connected to the input 21 of the associated ballast 20 by means of control lines 31, so that said ballast receives the DALI or DSI commands at its input in conventional fashion. From the point of view of the ballast 20, it is thus a regular part of the respective group and can communicate with the associated control unit 10/1 or 10/2—like the appliances 20/1 to 20/3 and 20/6 to 20/8 too—in conventional fashion, with data transmission taking place at least to some extent via the wireless connection between control unit 10/1 or 10/2 and wireless receiver 30, however. In addition, a special feature may be provided if the ballasts 20 are devices from the Tridonic company. These devices often have what is known as a smart port 22 that can be used to ensure the supply of power to the receiver 30 by the electronic ballast 20. In this case, the corresponding smart port can be used to forward the wirelessly received command to the electronic ballast 20 directly too without the need for a connection to the inputs 21 for the purpose of receiving the DALI or DSI commands.

Each control unit 10/1 or 10/2 is thus then responsible for the actuation of the ballasts 20 associated therewith. Advantageously, the ballasts 20 can be grouped into a group such that they are situated in direct proximity to one another or at least standard luminaire operation is appropriate. Accordingly, provision is preferably made for the control unit 10/1 or 10/2 to actuate the respective electronic ballasts 20 in standard fashion, particularly within the context of what are known as broadcast commands. That is to say that a DALI or DSI command transmitted from the output side of the respective control unit 10/1 or 10/2 is directed at all the ballasts 20 in the associated group and is received and implemented by said ballasts in standard fashion. However, this does not necessarily have to mean that the respective associated luminaires are also operated at identical brightness. By way of example, a correspondingly transmitted command may also be the selection of a preset lighting scene. In this case, the individual ballasts 20 each have brightness values stored in advance for the relevant scene that prescribe the way in which or the brightness at which the luminaire needs to light up when a particular scene is selected. In this case, these preset values may differ from luminaire to luminaire, so that when a corresponding scene command is transmitted the respective ballasts are thus by all means also able to set different brightness values. If, by contrast, the control unit 10/1 or 10/2 transmits a brightness control value directly in broadcast mode, this then results in all the electronic ballasts operating the corresponding light sources at the same brightness, for example at 50% of the maximum brightness.

This similar or standard actuation of all the operating devices in a group has been found to be particularly advantageous, which in this case the involvement for starting up the system 1 is extremely low. However, it would naturally also be conceivable for the control units 10/1 and 10/2 to actuate the luminaires individually at a respective operating address, as the DALI standard allows, for example. In this case, however, the involvement for starting up the system 1 is increased, since the luminaires or the operating devices then each need to be assigned individual addresses in advance.

In this case, the control units 10/1 and 10/2 generate the control commands for the associated operating devices 20 on the basis of control information that is made available to them externally. In this case, however, a fundamental difference of the known lighting systems is that the control units 10/1 and 10/2 receive this information wirelessly, in principle, and then process it further internally. The result of this is that—as is evident from the illustration in FIG. 1—it is not necessary for the control units 10/1 and 10/2 to have their input sides connected to data lines for signal transmission. Instead, it is merely necessary for the control units 10/1 and 10/2 each to have an interface 12 for wireless communication, this interface 12 also being able to be used to communicate wirelessly with the relevant ballasts or the receivers 30 thereof in the special cases described above.

In this case, the intelligence for processing the control information in control commands resides in the control units 10/1 and 10/2 themselves. That is to say that the control units 10/1 and 10/2 themselves take the control information as a basis for producing the control commands for the electronic ballasts 20 and, in particular, are also capable of taking account of additional information concerning external influences when the luminaires are actuated. This may be particularly information that is transmitted by presence or brightness sensors, for example. In this case, by way of example, the control units 10/1 and 10/2 then store appropriate dimming curves or the like, which stipulate the manner of the reaction to the incident exterior light from the outside. The control units 10/1 and 10/2 may also have a respective stipulation concerning the required manner of reaction to the detection of the presence of people.

In the exemplary embodiment in FIG. 1, two units that are responsible for producing and transmitting control information to the control units 10/1 and 10/2 are thus sensors 40, 41 that sense the presence of people (sensor 40) and provide information regarding the brightness of the exterior light (sensor 41). Since such sensors 40, 41 are usually arranged at very inaccessible positions inside or outside a building, the subsequent laying of lines for supplying power to such sensors is often very involved. In this case, provision is therefore preferably made for the sensors 40, 41 to have an independent power supply, for example a battery or the like. In the case of exterior light sensors, it would naturally also be possible to use solar cells or the like as power sources.

Furthermore, however, the system 1 also has other units that are used to transmit information to the control units 10/1 and 10/2. These may be classical operating control elements 42, 43 such as light switches, dimmers and the like that are either installed permanently or are available in the form of portable operator control units. Regardless of this, these units 42, 43 also transmit the information produced upon operation by a user to the control units 10/1 and 10/2 wirelessly.

In addition, FIG. 1 shows a further operator control element 44 that allows the various lighting scenes already mentioned previously to be easily called, for example. This element 44 has a plurality of pushbutton switches 45 that, when operated, each signal the selection of a particular lighting scene, these pushbutton switches 45 then also being stored with corresponding light sources in order to indicate the selection of a particular scene by means of appropriate lighting. In this case, provision may now be made for a plurality of such operator control elements 44 to be situated within a room or an area, in which case preferably the information transmitted from such an operator control element 44 to the control units 10/1 and 10/2 is also interchanged and accordingly all the operator control elements 44 each provide the same indication. This ensures standard indication of the selected lighting scene on the operator control elements 44.

Finally, control information can also be generated by two further units, these units being used primarily for implementing the system 1 as a whole. Using what is known as a setup box 46, for example, the control units 10/1 and 10/2 can each be notified of the group to which they have been allocated and/or in what way they need to react to the arrival of signals that come from the sensors 40, 41. It is also possible for the transmission of the preliminarily corresponding brightness values for the various lighting scenes to be effected using this setup box 46. In the same way, however, it would also be possible for appropriate configuration of the system 1 to be effected by a portable device 47 that, particularly by using a graphical user interface, allows particularly simple and comprehensible configuration.

Apart from the control information coming from these units shown on the left-hand side of FIG. 1, the control units 10/1 and 10/2 can also interchange information with one another, however. This may serve particularly to ensure standard operation of the system 1 as a whole. If one of the operator control elements transmits a command for selecting a brightness scene, for example, this command can be forwarded by the units 10/1 and 10/2 among one another as part of what is known as a repeater function in order thereby to ensure that this command has also actually been received by all the control units 10/1 and 10/2 in the system 1.

Ultimately, it is thus evident that the system 1 according to the invention provides all the opportunities for convenient brightness control, that the involvement for wiring the units to one another, particularly by means of lines for signal transmission, is significantly reduced.

The advantage of the system according to the invention becomes particularly clear in this case from an example that is shown in FIG. 2. Thus, the left-hand side of FIG. 2 first of all shows the conventional lighting, for example in a classroom 100, which merely involves conventional wiring of the various luminaires and uses simple switches 105 to allow the separate switching on and off firstly of luminaires 110, which are in the front area close to the blackboard 111, and secondly of three strip lights 120 extending in a longitudinal direction. If appropriate, provision could also be made here for dimming.

If the intention is now to allow convenient lighting control, however, which allows preset scenes (for example presentation, lesson, etc.) to be called and information provided by sensors to be incorporated, the previous solutions would require additional wiring of all of the luminaires to be performed using data lines.

However, the solution according to the invention also allows conversion to be performed, the embodiment shown on the right-hand side of FIG. 2 is obtained. In this case, a total of four groups 130/1 to 130/4 are formed, which correspond firstly to the blackboard lighting and secondly to the three strip lights extending in a longitudinal direction. In this case, each group 130/1 to 130/4 contains a control unit 131/1 to 131/4 that actuates the luminaires in the associated group as appropriate. Since the luminaires in a group each form a separate strip light anyway and accordingly usually have a common support element or even a common housing, the involvement for connecting the luminaires in a group to the respective controller is relatively simple to implement. However, it is not necessary for the control units 131/1 to 131/4 each to be additionally connected to external units by means of data lines. Instead, the actuation is now effected by using two pushbutton switches or operator control elements 135, 136 that transmit appropriate information to the control units 131/1 to 131/4 by radio. In addition, it is now a simple matter for even completely independently powered sensors 137 and 138 to be integrated into the system in order to allow automated actuation.

This example shows very clearly that the solution according to the invention can be used very easily and with little involvement to significantly increase the convenience of actuating luminaires.

In this case, the wireless communication between the various units in the system is preferably effected on the basis of a standard that allows very simple and low-power communication setup. In this context, particularly the known Bluetooth standard, preferably the 4.0 standard or communication by means of Bluetooth low energy, has been found to be appropriate. Preferably, the communication in this case is in a form such that it takes place only within a particular area, preferably within a room. Similar systems may then be situated in adjacent rooms, with the assurance that the wireless communication of the units within one room does not impair the communication of the units in another room.

1. A lighting system having at least one control unit that is designed to transmit to a plurality of operating devices associated therewith control commands, particularly control commands based on the DALI and/or DSI standard, wherein the control commands are generated on the basis of control information that is supplied to the control unit, wherein the control unit receives the control information wirelessly.

2. The lighting system as claimed in claim 1, wherein the control unit actuates the operating devices associated therewith in a standard manner.

3. The lighting system as claimed in claim 1, wherein the control unit is connected to at least one operating device associated therewith by means of a data line.

4. The lighting system as claimed in claim 1, wherein the control unit transmits to at least one operating device associated therewith the control commands wirelessly.

5. The lighting system as claimed in claim 1, wherein said system has a plurality of control units that each have an associated group of operating devices, wherein at least some of the control information supplied to a control unit also comes from one of the other control units.

6. The lighting system as claimed in claim 1, wherein at least some of the control information supplied to the control unit comes from a sensor, particularly from a presence or brightness sensor.

7. The lighting system as claimed in claim 6, wherein the sensor has an independent power supply, particularly a battery or a solar cell.

8. The lighting system as claimed in claim 1, wherein at least some of the control information supplied to the control unit comes from an operator control element that can be operated by a user.

9. The lighting system as claimed in claim 1, wherein said lighting system has a plurality of operator control elements, wherein at least some of the operator control elements are designed to wirelessely interchange information concerning the control information transmitted to the control unit.

10. The lighting system as claimed in claim 1, wherein the wireless communication of the control unit is effected on the basis of Bluetooth communication, preferably based on the Bluetooth standard 4.0 or by means of Bluetooth low energy.

11. A control unit for use in a lighting system, wherein the control unit is designed to transmit to a plurality of operating devices associated therewith control commands, particularly control commands based on the DALI and/or DSI standard, wherein the control commands are generated on the basis of control information that is supplied to the control unit wherein the control unit has means for wirelessly receiving the control information.

12. A method for actuating operating devices in a lighting system using a control unit that to transmit to a plurality of operating devices associated therewith control commands, particularly control commands based on the DALI and/or DSI standard, wherein the control commands are generated on the basis of control information that is supplied to the control unit wherein the control information is transmitted to the control unit wirelessly.
